(19) United States
(12) Patent Application Publication
(10) Pub. No.: US 2024/0340647 A1
(43) Pub. Date: Oct. 10, 2024

(54) ANTENNA ACTIVATION FOR SPECTRUM ACCESS CONTROL

(71) Applicant: AT&T Intellectual Property I, L.P., Atlanta, GA (US)

(72) Inventor: Joseph Soryal, Glendale, NY (US)

(73) Assignee: AT&T Intellectual Property I, L.P., Atlanta, GA (US)

(21) Appl. No.: 18/297,977

(22) Filed: Apr. 10, 2023

(51) Int. Cl. H04W 12/08; H04W 12/06; H04W 12/108

(52) U.S. Cl. CPC H04W 12/08; H04W 12/06; H04W 12/108

(57) ABSTRACT

Aspects of the subject disclosure may include, for example, a method including tracking a determination, by a processing system including a processor, whether to grant, deny or modify access to target spectrums by a user device and generating a temporary transmission access key that mirrors the determination. The method further includes transmitting the temporary transmission access key to a spectrum access control implementor. The spectrum access control implementor is coupled to an antenna that transmits or receives a radio signal in the target spectrums and selectively activates or deactivates a connection to the antenna. Other embodiments are disclosed.

### FIELD OF THE DISCLOSURE

The subject disclosure relates to network-based systems and methods to selectively activate an antenna of a wireless communication network to perform spectrum access control.

### BACKGROUND

Conventional mobile devices can typically exchange data through a variety of interfaces, such as Licensed Cellular, Wi-Fi, or Bluetooth. Each of these interfaces may be enabled or disabled by the subscriber, depending on their network circumstances.

Citizens Broadband Radio Service (CBRS) is authorized by the Federal Communications Commission (FCC) for use by the government and certain businesses as well as general authorized access by unlicensed users. Access to CBRS may be controlled depending on tiers of users which reflect access priority to CBRS.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a spectrum access control system in accordance with various aspects described herein.

FIG. 2B is a block diagram illustrating an example, non-limiting embodiment of a spectrum access control system operating with a radio unit in accordance with various aspects described herein.

FIG. 2C is a block diagram illustrating an example, non-limiting embodiment of a spectrum access control implementor in accordance with various aspects described herein.

FIG. 2D is a block diagram illustrating an example, non-limiting embodiment of a spectrum access control system operating within Citizens Broadband Radio Service (CBRS) spectrum in accordance with various aspects described herein.

FIG. 2E is a block diagram illustrating an example, non-limiting embodiment of a spectrum access control system operating within Open Radio Access Network (ORAN) in accordance with various aspects described herein.

FIG. 2F depicts an illustrative embodiment of a method including generating a temporary transmission access key in accordance with various aspects described herein.

FIG. 2G depicts an illustrative embodiment of a method including receiving a temporary transmission access key in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for controlling access to target spectrums by selectively activating an antenna of a wireless communication network. In one or more embodiments, a temporary transmission access key is generated. The temporary transmission access key mirrors a determination that grants access or denies access to the target spectrums. The temporary transmission access key is transmitted to a processing system coupled to the antenna. To grant access, the processing system is configured to activate a connection of the antenna to the wireless communication network. To deny access, the processing system is configured to deactivate the connection of the antenna to the wireless communication network. The processing system is arranged to be an in-line circuit with the antenna. The processing system can be located adjacent to the antenna. The processing system may directly control operations of the antenna and selectively activate the antenna.

The temporary transmission access key may contain a time value that grants access to the target spectrums. The temporary transmission access key can include a zero time value to deny access to the target spectrums. The temporary transmission access key further specifies the target spectrums for transmission or reception by the antenna. The target spectrums can include licensed spectrums or unlicensed spectrums. Other embodiments are described in the subject disclosure.

One or more aspects of the subject disclosure include a device, including a processing system including a processor and operable to receive a temporary transmission access key periodically, and a memory that stores executable instructions that, when executed by the processing system, facilitate performance of operations, including parsing a message based on the temporary transmission access key, obtaining a time value included in the message of the temporary transmission access key, obtaining a target spectrum to be accessed via an antenna of a wireless communication network, and activating or deactivating a connection to the antenna to permit transmission in the target spectrum based on the obtained time value.

One or more aspects of the subject disclosure include a device, including a processing system including a processor and a memory that stores executable instructions that, when executed by the processing system, facilitate performance of operations, including tracking a determination of whether to grant or deny access to a target spectrum by a user device, generating a temporary transmission access key that mirrors the determination of whether to grant or deny access to the target spectrum by the user device, and transmitting the temporary transmission access key to a spectrum access control implementor coupled to an antenna operating in the target spectrum.

One or more aspects of the subject disclosure include a method, including steps of tracking a determination, by a processing system including a processor, of whether to enable or disable access to a target spectrum by a user device, generating, by the processing system, a temporary transmission access key that mirrors the determination whether to enable or disable the access to the target spectrum, and transmitting, by the processing system, the temporary transmission access key to a spectrum access control implementor coupled to an antenna operating in the target spectrum via a secure communication channel using a predetermined authentication process.

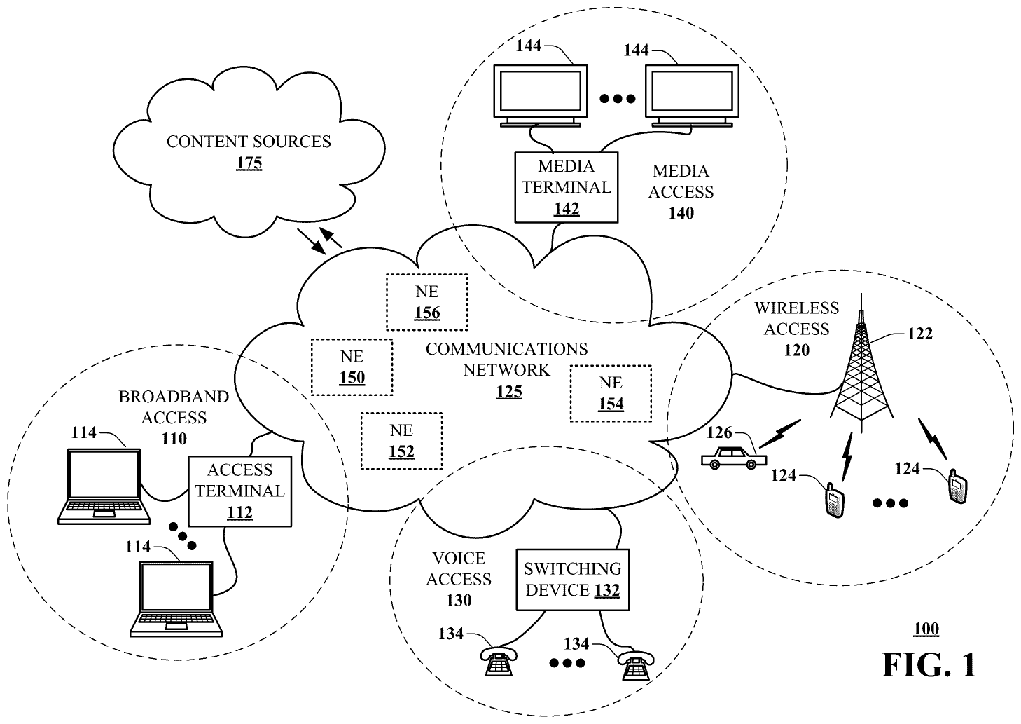

Referring now to FIG. 1, a block diagram is shown illustrating an example, non-limiting embodiment of a system 100 in accordance with various aspects described herein. For example, system 100 can facilitate in whole or in part spectrum access control systems and methods to selectively activate or deactivate an antenna of a wireless communication network in order to control access to intended spectrums. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VOIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VOIP gateway or other gateway device and/or other switching device. The telephony devices 134 can include traditional telephones (with or without a terminal adapter), VOIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

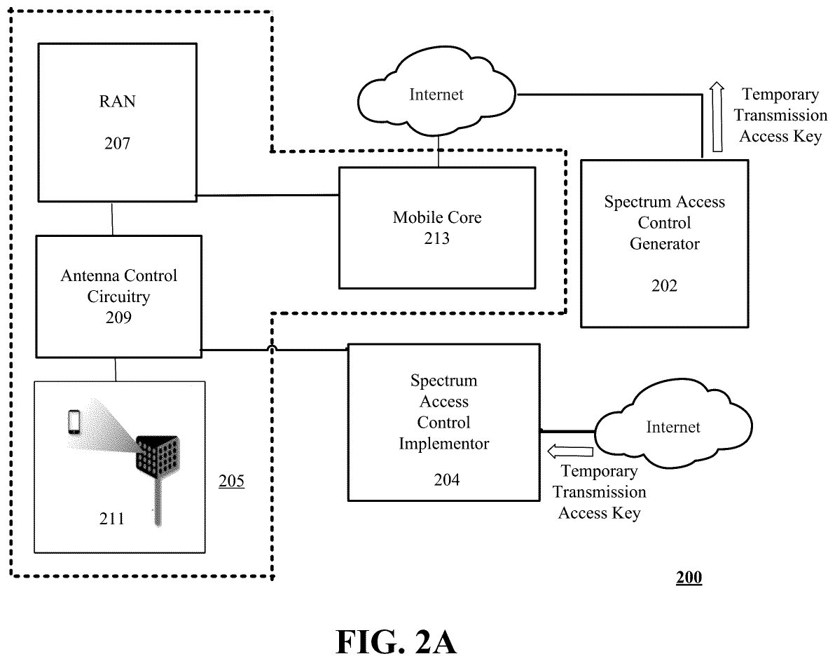

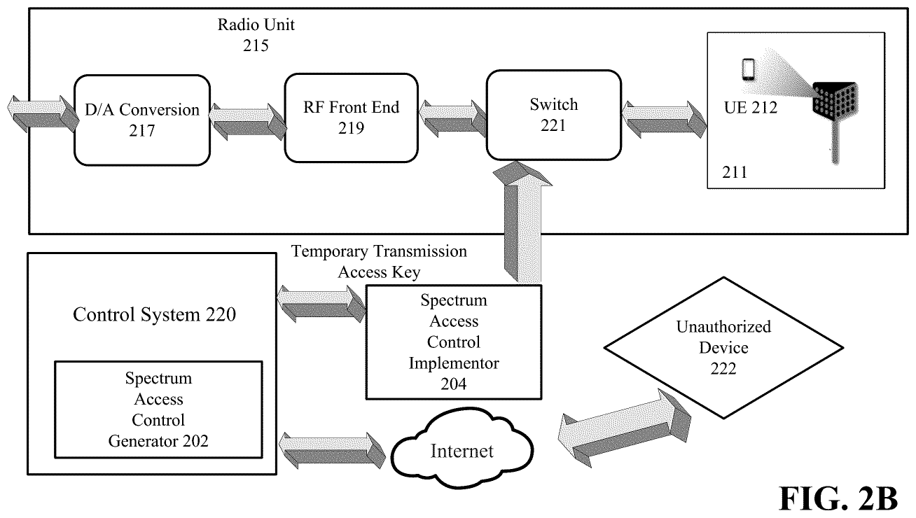

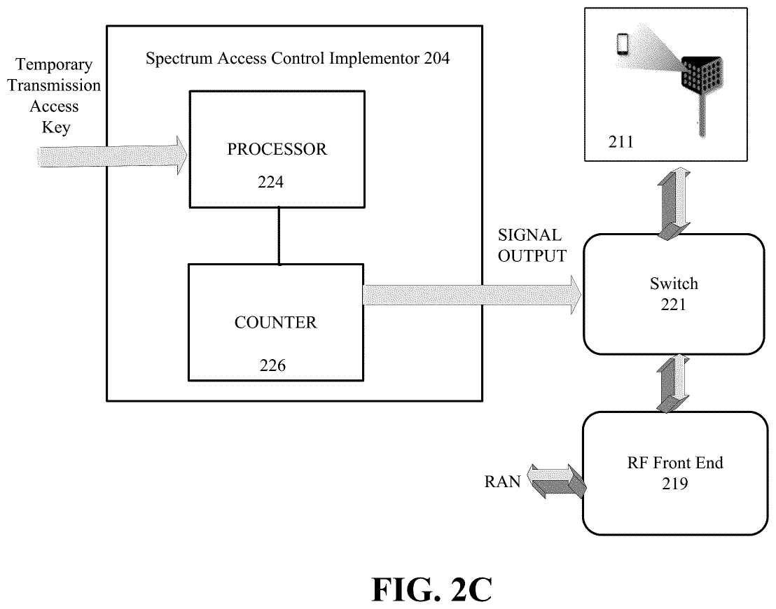

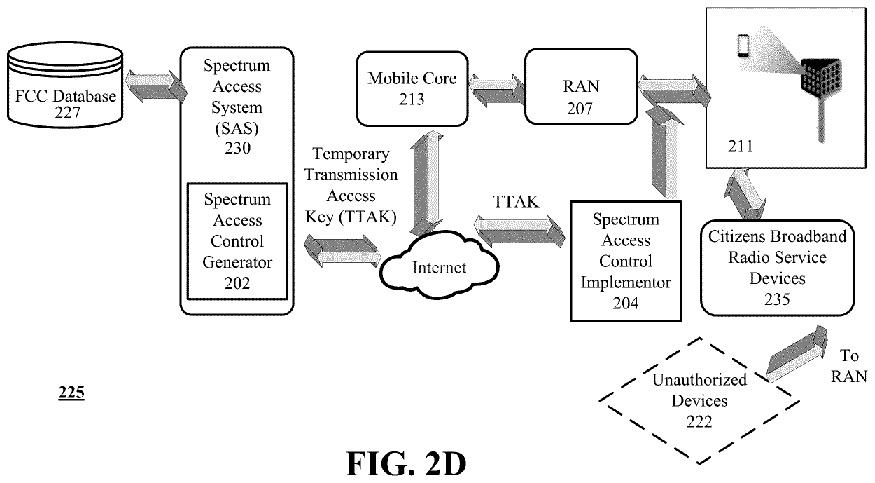

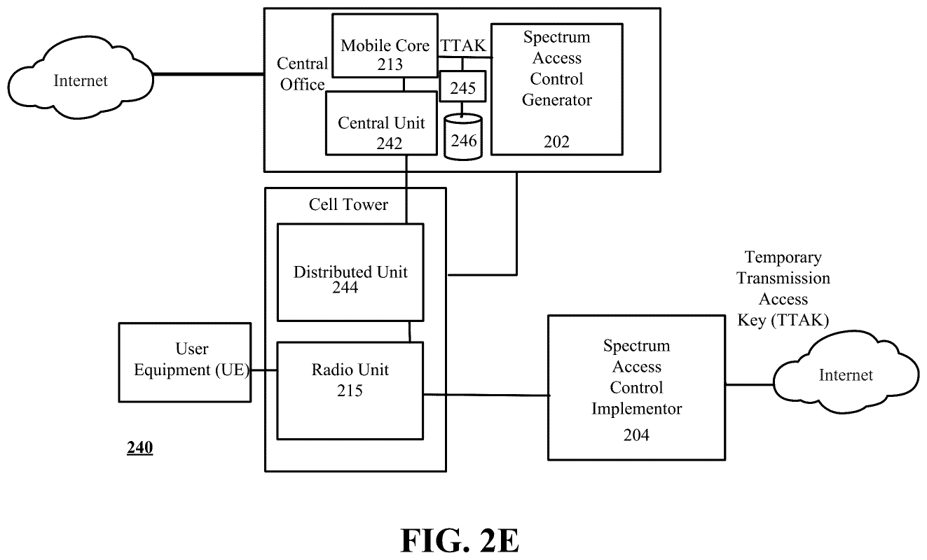

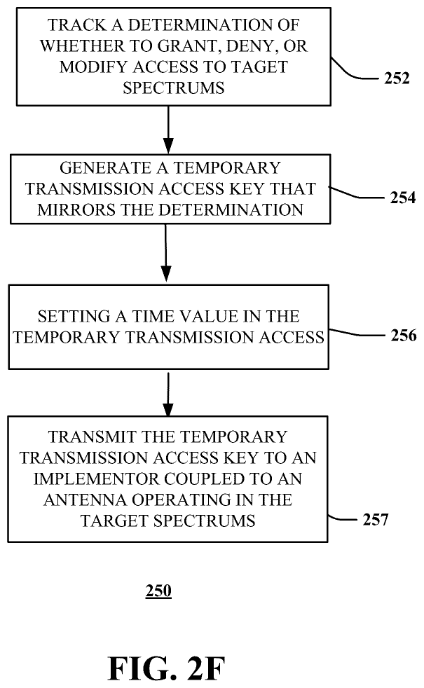

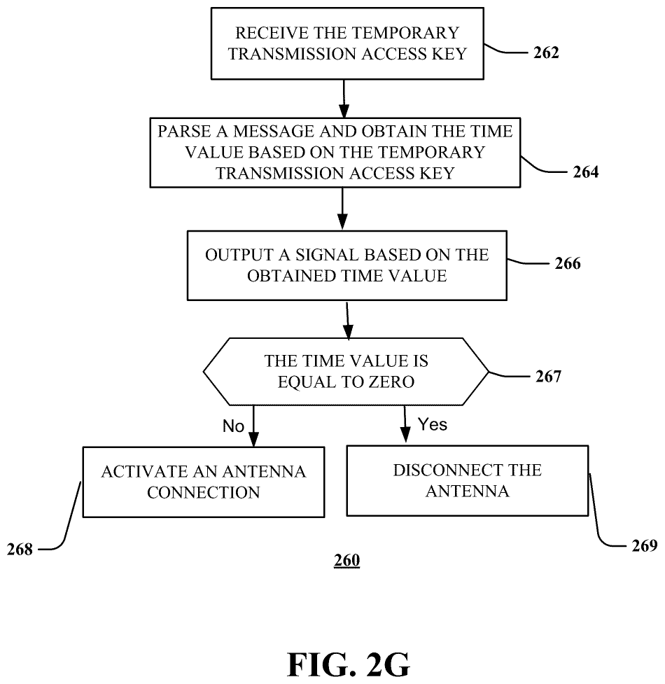

FIG. 2A is a block diagram illustrating an example, non-limiting embodiment of a spectrum access control system 200 within the communication network of FIG. 1 in accordance with various aspects described herein. A cellular network 205 includes a Radio Access Network (RAN) 207 and a mobile core 213. The mobile core 213 is connected to the internet. In one or more embodiments, the RAN 207 includes multiple base stations distributed to establish wireless channels for user equipment as illustrated with the wireless access 120, 122 and 124 in FIG. 1. The RAN 207 is coupled to antenna control circuitries 209 which is in turn connected to an antenna 211.

In various embodiments, the cellular network 205 utilizes licensed radio frequency spectrum or unlicensed spectrum. For example, 3G and 4G wireless communications use licensed spectrum, such as bands of 850 MHz Cellular, 1900 MHz PCS, 2300 MHz, etc. and 5G wireless communications use bands of 39 GHz, 850 MHz and 3.7 GHz. Alternatively, unlicensed spectrum may be utilized such as the ISM radio bands, which is a portion of the radio spectrum reserved internationally for industrial, scientific, and medical (ISM) purposes, excluding applications in telecommunications. In addition, Citizens Broadband Radio Service (CBRS) utilize a radio spectrum in the 3550-3700 MHz (3.5 GHz) band and is available for licensed and unlicensed users.

Referring to FIG. 2A, the spectrum access control system 200 includes a spectrum access control generator 202 and a spectrum access control implementor 204. In various embodiments, the spectrum access control implementor 204 and the spectrum access control generator 202 utilize existing communication link(s) and communicate via the internet and the cellular network 205. In one or more embodiments, the communication link(s) between the spectrum access control generator 202 and the spectrum access control implementor 204 serves as a secure communication channel. In various embodiments, a two-way authentication process applies to the communication link(s) between the spectrum access control generator 202 and the spectrum access control implementor 204. Along the existing communication link(s), the spectrum access control implementor 204 and the spectrum access control generator 202 may establish a new logical communication link using a virtual private network (VPN) tunnel.

In various embodiments, the spectrum access control generator 202 generates a temporary transmission access key and transmits to the spectrum access control implementor 204. In response to a received temporary transmission access key, the spectrum access control implementor 204 controls the antenna control circuitry 209 and selectively activates or deactivates the antenna 211 coupled to the antenna control circuitry 209. Once the antenna 211 is disconnected from the RAN 207, the antenna 211 may not be able to transmit or receive radio signals.

In various embodiments, the spectrum access control generator 202 operates with a control system which manages access and use of target spectrums, which will be further described below. For instance, the control system may include a Spectrum Access System (SAS) which manages and controls access to CBRS spectrum and the spectrum access control generator 202 (referred to herein as “the generator”) may reside in the SAS. In one or more embodiments, the generator 202 is an embedded process that follows determinations made by the SAS for using CBRS spectrum.

In various embodiments, the spectrum access control implementor 204 (referred to here as “the implementor”) is connected to the antenna control circuitry 209. As will be described in detail below, the implementor 204 selectively activates or deactivates the antenna 211 by controlling the connection between the RAN 207 and the antenna 211.

FIG. 2B is a block diagram illustrating an example, non-limiting embodiment of the spectrum access control system 200 in communication with a radio unit 215 in accordance with various aspects described herein.

In various embodiments, the radio unit 215 includes a D/A conversion module 217, an RF front end 219, a switch 221 and the antenna 211. In other embodiments, the radio unit 215 may include other RAN functionalities and circuitries. The implementation of the radio unit 215, illustrated in FIG. 2B, is by way of example only and various other modifications are possible according to different wireless communication standards such as 4G, 5G, etc.

In various embodiments, the RF front end 219 may include circuitries for transmitting and receiving radio signals. The switch 221 is arranged between the RF front end 219 and the antenna 211. The switch 221 is activated or deactivated based on an input from the implementor 204. Upon activation of the switch 221, the antenna 211 and the RF front end 219 are coupled and in turn the antenna 211 is activated. Wireless communication channels to/from user equipment 212 are established. Alternatively, upon deactivation of the switch 221, the connection between the antenna 211 and the RF front end 219 is open-circuited and the antenna 211 becomes inactive. Various configurations of the switch 221 are possible as long as the switch 221 performs the functions described herein. A two-way authentication process may apply to the communication between the implementor 204 and the switch 221 in order to enhance security, stability and connectivity of the RAN 207 and the cellular network 205.

In various embodiments, the switch 221 may be implemented as hardware component(s) and/or software functions/processes. By way of example, the switch 221 includes software defined RF filters that may allow target spectrums to pass from the RF front end 219 to the antenna 211. The implementor 204 may pass target spectrum information to the switch 221. Additionally or alternatively, the switch 211 acts as a software defined router and in response to a valid temporary transmission access key coming to the switch 221, a route may be open between the RF front end 219 and the antenna 211. In absence of a valid input (e.g., a valid temporary transmission access key), the switch 211 may shut off the route between the RF frond end 219 and the antenna 211. Additionally, or alternatively, the switch 221 performs a monitoring process to detect unauthorized attempts to connect from the implementor 204. Additionally, or alternatively, if spectrums other than the target spectrums or target spectrums are pushed by the RF front end 219 to the antenna 211, then this monitoring process may send an alarm to a certain IP address to an operator (e.g., the control system 220) detailing potential security issues or potential Denial of Service (DOS) attacks.

In various embodiments, the implementor 204 is arranged to be coupled to the RF front end 219 and the switch 221. The implementor 204 is in communication with a control system 220, more specifically, the generator 202 residing in the control system 220. As depicted in FIG. 2B, the generator 202 is included in the control system 220. In some embodiments, the generator 202 is implemented as a hardware in or coupled to the control system 220. In other embodiments, the generator 202 is implemented as software module(s) and may be an embedded process that mirrors a determination of the control system 220.

The control system 220 manages and controls target spectrums such as CBRS and receives a request to use or access the target spectrums from a transmitting device. In one or more embodiments, the transmitting device includes user equipment, Citizens Broadband Radio Service Devices (CBRDs), IoT devices, etc. In response to the request to use the target spectrums, the control system 220 may determine to grant or deny access to the target spectrums. In one or more embodiments, the control system 220 may detect unauthorized access to the target spectrums, a prioritized use request, etc. and may determine to grant or deny access, or modify current access to the target spectrums.

In various embodiments, the generator 202 operates to mirror the determination made by the control system 220 and provide a temporary transmission access key as depicted in FIGS. 2A and 2B. The temporary transmission access key allows a transmitting device such as the user equipment 212 to access radio in the target spectrums. Alternatively, the temporary transmission access key may deny the transmitting device to access radio in the target spectrums.

In various embodiments, the temporary transmission access key may be sent to the implementor 204 via an existing secure communication link between the control system 220 (i.e., the generator 202) and the implementor 204. In one or more embodiments, the generator 202 may directly send the implementor 204 on top of the existing secure communication link. The temporary transmission access key enables the antenna 211 to be sequentially and selectively activated or deactivated for a specified time. The temporary transmission access key gets renewed periodically depending on demands for radio bandwidth. For instance, if there are high bandwidth demands of the target spectrums from a prioritized user and the general public, the temporary transmission access key may be sent for short periods allowing the antenna 211 to switch between uses by the prioritized user and the general public.

In various embodiments, the temporary transmission access key may contain a specific frequency spectrum to be transmitted through the antenna 211. For instance, if the target spectrums are directed to CBRS spectrum, the specific frequency spectrum is in the 3550-3700 MHz (3.5 GHz). As another example, the target spectrums include various 4G, 5G frequency bands and are not limited to a particular spectrum band.

FIG. 2C is a block diagram illustrating an example, non-limiting embodiment of the implementor 204 in accordance with various aspects described herein. In various embodiments, the implementor 204 includes a processor 224 and a counter 226. The implementor 204 receives the temporary transmission access key by the processor 224. The implementor 204 then parses a message based on the temporary transmission access key and obtains a time value. By way of example only, the time value may be two minutes and the implementor 204 will be activated for two minutes. The antenna 211 is activated and connected to the rest of the RAN and operates to transmit and receive radio signals for two minutes. If two minutes expire, the connection between the antenna 211 and the rest of the RAN will be deactivated until and unless the implementor 204 receives a new or renewed temporary transmission access key from the generator 202. As another example, while the time value is still valid, the generator 202 may send a new temporary transmission access key having zero time value in order to terminate a current access to the target spectrums for providing access to a higher priority user, or upon determination that the current access is recognized as an unauthorized or illegal transmissions by hackers, terrorists, etc.

In various embodiments, the processor 224 transmits the obtained time value to the counter 226. In one or more embodiments, the counter 226 counts the time down per second. While the counter 226 is busy, i.e., counting down operation is ongoing, an output signal is provided to the switch 221 and turn on the switch 221. As depicted in FIG. 2C, the switch 221 bridges the RF front end 219 and the antenna 211. As a result, the antenna 211 is connected to the RF front end 219 and the rest of the RAN. Alternatively, if the counter 226 is idle, i.e., not counting down, based on the obtained time value being zero, no output signal is present and the switch 221 is turned off. As a result, the RF front end 219 and the antenna 211 are disconnected and no transmission/reception of radio signals take place via the antenna 211. Additionally, or alternatively, the counter 225 may be implemented as a hardware module or software functions. In other embodiments, the counter 225 may have different configurations and functions such as a counting up counter to a preset value, a timer, etc.

In various embodiments, the implementor 204 is implemented as an in-line circuit between the RF front end 219 and the antenna 211. Deactivation or disconnection of the in-line circuit may directly lead to the disconnection between the antenna 211 and the rest of the RAN 207. The implementor 204 may facilitate a direct control of the antenna 211 which selectively allows transmission and reception of radio signals in the target spectrums. The direct control of the antenna 211 may facilitate improved management of the target spectrum access and use, and security threat and DOS attack by unauthorized devices and/or entities can be prevented by blocking transmission of unauthorized network traffic. RAN components that could have been compromised and/or malfunction by the unauthorized signals and data can be protected by shutting down transmission/reception at the antenna stage.

In various embodiments, the implementor 204 may be implemented as a hardware component or software functions/processes. The implementor 204 may be positioned adjacent to the location of the antenna 211. In one or more embodiments, the antenna 211 may be located at a cell tower, a WiFi access point, etc. The implementor 204 may be located at the same cell tower or the same access point with the antenna 211. The implementor 204 may be associated with the radio unit 215, for instance, between the antenna 211 and the RF front end 219. In some embodiments, the implementor 204 and the switch 211 may be integrated and therefore, the implementor 204 is activated or deactivated based on the time value of the temporary transmission access key and operates as a switch.

FIG. 2D depicts an illustrative embodiment of a use case of a spectrum access control system 225 in the CBRS spectrum in accordance with various aspects described herein. The spectrum access control system 225 is not limited to use of the CBRS spectrum and available for use in various frequency bands. As described above, CBRS operates in a frequency band that is available on three-tier user bases: Tier 1 users correspond to incumbent access, Tier 2 users correspond to priority access, and Tier 3 users correspond to general authorized access. Tier 1 users include government, satellites, Department of Defense, etc., and Tier 2 users priority access license (PAL) users. As depicted in FIG. 2D, FCC database 227 include information as to Tier 1, Tier 2 and Tier 3 users and relevant licenses. A Spectrum Access System (SAS) 230 has access to the information stored in the FCC database 227 and determines registered users and their relevant tiers/priorities in accessing CBRS.

If a higher tier user (e.g., Navy radar) requests a bandwidth access, the SAS 230 commands Citizens Broadband Radio Service Devices (CBSD) 235 having a lower tier to stop transmitting on the frequencies requested by the higher tier user or preempt access to the frequencies requested by the higher tier user from the lower tier users.

In various embodiments, the CBSD 235 include mobile phones, IoTs, etc. CBSD 235 are mandated to be installed by certified installers. However, the CBSD 235 may be subject to hacking or controlled by unauthorized users and in that case, despite a request from the SAS 292, the CBSD 235 may refuse to stop using the spectrum. If such refusal may happen, interference with the Tier 1 users such as Navy, Department of Defense, etc. may amount to a denial of service (DOS) attack on Tiers 1 and 2 users. The denial of service attack may shut down a machine or network, making it inaccessible to its intended users. Hacked CBSD 235 and/or unauthorized devices 222 may flood the CBRS spectrum with traffic, or sending information that triggers a crash and may potentially deprive Tiers 1 and 2 users of the service or resource that they needed and expected.

In various embodiments, the generator 202, as depicted in FIG. 2D, is an embedded process that mirrors the decisions made by the SAS 292 to the CBSD 235 to deny or grant the access to CBRS spectrum. Upon determination that the CBDS 235 or the unauthorized devices 222 should stop using the CBRS spectrum, the generator 202 mirrors the determination by the SAS 292 and generates a temporary transmission access key corresponding to the determination. In order to stop the transmission and access to the spectrum, the temporary transmission access key may have a time value of “zero” and will be sent to the implementor 204. As discussed above in conjunction with FIG. 2C, the implementor 204 may be implemented as an in-line circuit between the RF front end 219 and the antenna 211. The processor 224 of the implementor 204 receives the temporary transmission access key and parses a message and the time value. The counter 226 receives the time value (i.e., “0” time value here) from the processor 224 and becomes idle. The implementor 204 is deactivated and becomes an open circuit or deactivates the switch 221, as depicted in FIG. 2C. As a result, the antenna 211 is disconnected to the RAN functions and circuitries and the unauthorized devices and/or the CBSD 235 may not transmit and/or receive radio signals using the CBRS spectrum.

In various embodiments, the spectrum access control system in accordance with the present disclosure operate to turn off certain spectrums to reduce interference for higher priority communications such as emergencies by first responders (e.g., FirstNet). Additionally, or alternatively, the spectrum access control system operates to turn off communications for national security events such as U.S. President visits or military drills. Furthermore, the spectrum access control system operates to turn off communications from a targeted geographic area to prevent or capture particular communications by cybercriminals or terrorists. The spectrum access control system is not limited to the foregoing use cases and various other uses and applications are possible. The spectrum access control system is not limited to use of the CBRS spectrum and available for use in various frequency bands.

FIG. 2E is a block diagram illustrating an example, non-limiting embodiment of a spectrum access control system 240 operating within Open Radio Access Network (ORAN) in accordance with various aspects described herein. As depicted in FIG. 2E, the mobile core 213 and a central unit 242 are co-located at the Central Office, and the radio unit 215 and a distributed unit 244 are co-located at a cell tower. The Central Office may be deployed in one or more clouds including a central cloud, an edge cloud, or both. The configuration of the ORAN as depicted in FIG. 2E is by way of example and various modifications and/or different configurations are possible. Descriptions of the ORAN are provided in conjunction with the spectrum access control system.

As depicted in FIG. 2E, the generator 202 resides in the Central Office and is coupled to the mobile core 213. In various embodiments, the mobile core 213 and/or the Central Office includes a logic 245 that manages and controls the target spectrums, unauthorized access to the target spectrums, prioritized access to the target spectrums and a database 246 that stores relevant data such as authorized users, relevant licenses, geographical restrictions, different tiers of users, etc. The logic 245 may determine a time value of a temporary transmission access key and a period for generating the temporary transmission access key, as discussed above in connection with FIGS. 2B-2D.

In various embodiments, the logic 245 may be trained via machine learning techniques. The logic 245 can be adapted to learn based on past experience and past data sets to determine an optimal time value for the temporary transmission access key in various use cases within the ORAN.

As described in the above embodiments, the generator 202 generates a temporary transmission access key and transmit the temporary transmission access key to the implementor 204 via a secure communication link directly or indirectly. The implementor 204 is coupled to the radio unit 215 including the antenna 211 (see FIG. 2B) and selectively activates or deactivates the connection between the antenna 211 and the rest of the ORAN components based on the temporary transmission access key received from the generator 202.

FIG. 2F depicts an illustrative embodiment of a method 250 used by the systems 200, 225 and 240 for controlling spectrum access by activating or deactivating an antenna in wireless communication systems in accordance with various aspects described herein. In one or more embodiments, a control system which manages or controls target spectrums detects triggering events and determines to grant, deny or modify a current access to the target spectrums. By way of example, the triggering events include unauthorized uses of target spectrums, prioritized uses of target spectrums, a request targeting restricted regions, a request from a higher tier user or group, a request relating to national security related events, etc. In one or more embodiments, the control system detects that a request from a user device occupies bandwidth of the target spectrum over a predetermined threshold. The control system may detect that another user device transmits information that triggers a crash of a wireless communication network. Upon detecting the trigger events, the control system determines whether to grant, deny or modify use of, or access to the target spectrums.

The generator 202 tracks determinations by the control system at Step 252. The generator 202 generates the temporary transmission access key that mirrors the determination of the control system 220 at Step 254. At Step 256, the generator 202 is configured to set a time value to the temporary transmission access key based on the tracked determination. If the tracked determination is to deny access to the target spectrum, then the generator 202 sets zero time value to the temporary transmission access key at Step 254. If the tracked determination is to grant access to the target spectrum, then the generator 202 sets non-zero time value that is responsive to various parameters such as a tier of a user, bandwidth availability, emergency nature of network events, a DOS attack, a major security threat, a matter of national security, etc. Additionally, or alternatively, the generator 202 may add information specifying a target frequency spectrum for transmission by the antenna 211 at Step 256. The target frequency spectrum includes various frequency bands available in the wireless communication networks. The generator 202 transmits the temporary transmission access key to the implementor 204 via the secure communication link at Step 257. In one or more embodiments, a two-way authorization process applies to the transmission of the temporary transmission access key.

FIG. 2G depicts an illustrative embodiment of another method 260 used by the systems 200, 225 and 240 for controlling spectrum access by activating or deactivating an antenna for transmitting and/or receiving radios in accordance with various aspects described herein. In one or more embodiments, the implementor 204 receives a temporary transmission access key from a control system 220 at Step 262. The control system 220 manages and controls use and access of target spectrums such as CBRS, ORAN, Wifi, 4G cellular network, etc.

In various embodiments, the temporary transmission access key includes a time value during which transmission and reception of data are enabled via the antenna 211. The temporary transmission access key further includes information for target spectrums, such as a particular spectrum for transmission and/or reception of data and signals via the antenna 211. The implementor 204 parses a message from the temporary transmission access key and obtains the time value at Step 264. In one or more embodiments, the implementor 204 is coupled to the antenna 211 as an in-line circuit. Additionally, or alternatively, the implementor 204 is coupled to the switch 221 positioned between the RF front end 219 and the antenna 211. At Step 266, the implementor 204 provides an output signal based on the obtained time value. Upon determination that the time value is non-zero at Step 267, the implementor 204 is activated or output a signal that activates the switch 211 for a duration of the time value at Step 268t. Upon determination that the time value is zero at Step 267, the implementor 204 is deactivated or outputs a signal that deactivates a switch 221 at Step 269.

While for purposes of simplicity of explanation, the respective processes are shown and described as a series of blocks in FIGS. 2F and 2G, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

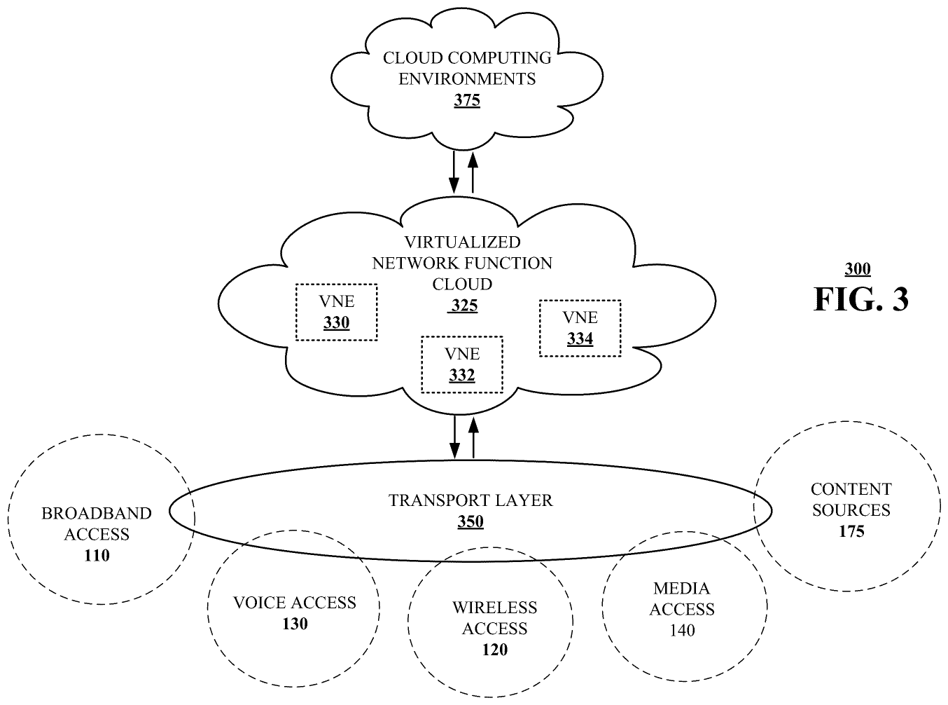

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200, and method presented in FIGS. 1, 2A-2G, and 3. For example, virtualized communication network 300 can facilitate in whole or in part determining a need to control access to target spectrums by the control system such as the SAS 230 (FIG. 2D) and the Central Office (FIG. 2E) and generating a temporary transmission access key by the spectrum access control generator that mimics the determination.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so, the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall, which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third party locations.

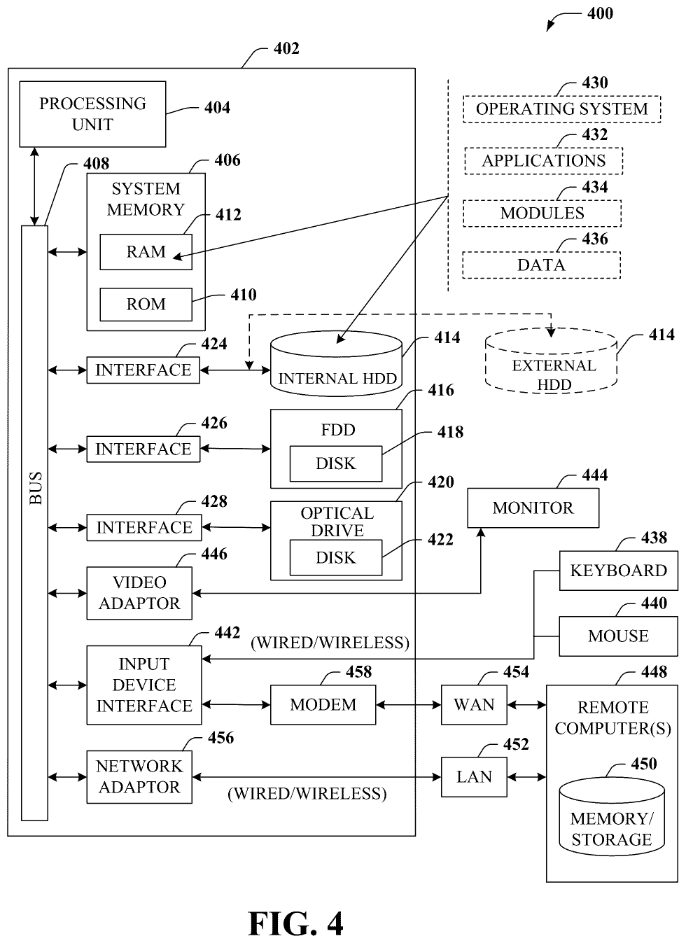

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part a spectrum access control implementor, a spectrum access control generator, and a control system that manages and controls use or access of intended spectrum, such as the Spectrum Access System, the Central Office, etc.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). A Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

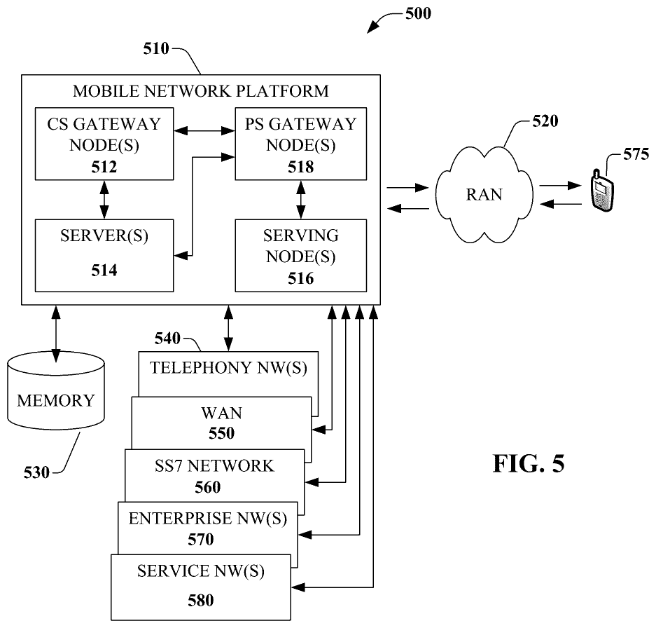

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part a spectrum access control generator, and a control system that manages and controls use or access of intended spectrum, such as the Spectrum Access System, the Central Office, etc.

In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It is should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

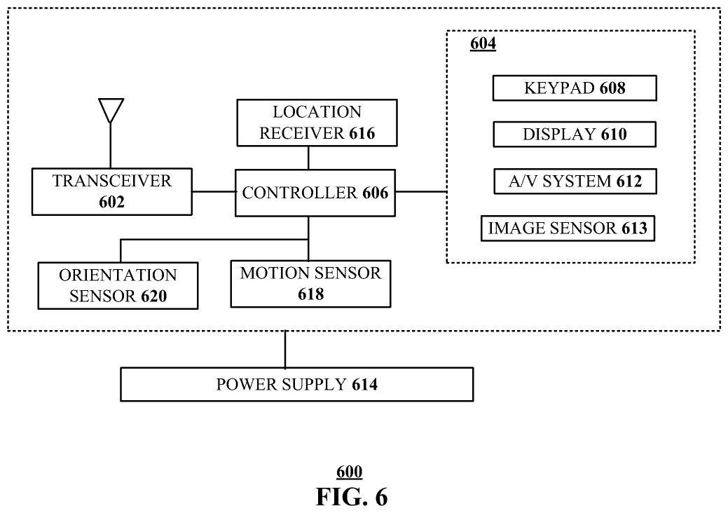

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part user equipment such as Citizens Broadband Radio Service Devices which transmit and receive signals and data via the antenna configured to be activated or deactivated by the spectrum access control system.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VOIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human car) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor;
a memory that stores executable instructions that, when executed by the processing system, facilitate performance of operations, the operations comprising:
receiving a temporary transmission access key periodically;
parsing a message based on the temporary transmission access key;
obtaining a time value included in the message of the temporary transmission access key;
obtaining a target spectrum to be accessed via an antenna of a wireless communication network; and
activating or deactivating a connection to the antenna to transmit a radio signal in the target spectrum based on the obtained time value.

2. The device of claim 1, wherein the operations further comprise providing an output signal that selectively activates the connection to the antenna while the obtained time value is counting down to zero.

3. The device of claim 2, wherein the operations further comprise:
receiving a renewed temporary transmission access key with a different time value when the obtained time value reaches zero; and
reactivating the connection to the antenna for a duration of the different time value.

4. The device of claim 1, further comprising a switch arranged between the antenna and an antenna control circuit of the wireless communication network; and
wherein the activating or deactivating the connection to the antenna further comprises activating or deactivating the connection to the antenna by turning on or off the switch based on the obtained time value.

5. The device of claim 1, wherein the target spectrum further comprises Citizens Broadcast Radio Service (CBRS).

6. The device of claim 1, wherein the processing system is located adjacent to the antenna of the wireless communication network.

7. The device of claim 1, wherein the operations further comprise:
communicating with a spectrum access control generator that generates the temporary transmission access key via a secure communication channel; and
receiving the temporary transmission access key from the spectrum access control generator via the secure communication channel using a predetermined authentication process.

8. The device of claim 1, wherein the processing system is arranged as an in-line circuit between the antenna and an antenna control circuit of the wireless communication network.

9. A device, comprising:
a processing system including a processor;
a memory that stores executable instructions that, when executed by the processing system, facilitate performance of operations, the operations comprising:
tracking a determination of whether to grant or deny access to a target spectrum by a user device;
generating a temporary transmission access key that mirrors the determination; and
transmitting the temporary transmission access key to a spectrum access control implementor coupled to an antenna operating in the target spectrum.

10. The device of claim 9, wherein the generating further comprises:
setting a time value of the temporary transmission access key to a predetermined time duration based on the determination that grants the access to the target spectrum.

11. The device of claim 9, wherein the generating further comprises:
setting a time value of the temporary transmission access key to zero based on the determination that denies access to the target spectrum.

12. The device of claim 9, wherein the tracking the determination further comprises:
detecting an unauthorized use to the target spectrum by a first user device that leads to a denial of service; and
tracking a determination to block the unauthorized use to the target spectrum by the first user device;
wherein the generating the temporary transmission access key further comprises generating the temporary transmission access key having a set time value of zero.

13. The device of claim 9, wherein the operations further comprise:
receiving a prioritized access request of the target spectrum from a second user device; and
wherein the tracking the determination further comprises tracking a determination to stop a current access to the target spectrum in response to the prioritized access request from the second user device.

14. The device of claim 9, wherein the operations further comprise:
detecting that the target spectrum corresponds to a spectrum of Citizens Broadband Radio Service (CBRS); and
detecting whether or not the user device is an authorized Citizens Broadband Radio Service Device (CBSD); and
wherein the tracking the determination further comprises tracking a determination to deny access to the target spectrum upon a determination that the user device is not the authorized CBSD.

15. A method, comprising:
tracking a determination, by a processing system including a processor, of whether to grant, deny, or modify access to a target spectrum by a user device;
generating, by the processing system, a temporary transmission access key that mirrors a tracked determination; and
transmitting, by the processing system, the temporary transmission access key to a spectrum access control implementor connected to an antenna operating to transmit a radio signal in the target spectrum via a secure communication channel using a predetermined authentication process.

16. The method of claim 15, wherein the generating further comprises:
setting, by the processing system, a time value of the temporary transmission access key to a predetermined time duration based on the determination that grants access to the target spectrum.

17. The method of claim 15, further comprising detecting, by the processing system, an unauthorized use to the target spectrum by the user device; and
wherein the generating further comprises setting, by the processing system, a time value of the temporary transmission access key to zero based on the determination that denies the unauthorized use to the target spectrum.

18. The method of claim 15, further comprising:
receiving, by the processing system, a prioritized use request of the target spectrum; and
wherein the tracking the determination further comprises tracking a determination, by the processing system, to terminate a current access to the target spectrum by the user device in response to the prioritized use request.

19. The method of claim 15, further comprising:
detecting, by the processing system, that the target spectrum corresponds to a spectrum of Citizens Broadband Radio Service (CBRS); and
detecting, by the processing system, whether or not the user device is an authorized Citizens Broadband Radio Service Device (CBSD); and
wherein the tracking the determination further comprises tracking a determination to disable the access to the target spectrum upon a determination that the user device is not the authorized CBSD.

20. The method of claim 15, further comprising:
detecting, by the processing system, that a request from the user device occupies bandwidth of the target spectrum over a predetermined threshold; and
wherein the generating the temporary transmission access key further comprises generating the temporary transmission access key, by the processing system, that deactivates the connection to the antenna upon detection that the user device occupies the bandwidth of the target spectrum over the predetermined threshold.
